(19) United States
(12) Patent Application Publication
(10) Pub. No.: US 2005/0034907 A1
(43) Pub. Date: Feb. 17, 2005

(54) Speed and direction control for vehicle

(76) Inventors: Walter Andrew Peregrim, Wilkes Barre, PA (US); Mark A. Goodell, Thornhurst, PA (US); George L. Leitner JR., Tresckow, PA (US)

Correspondence Address: Thomas J. Durling;DRINKER BIDDLE & REATH LLP, One Logan Square, 18th & Cherry Streets, Philadelphia, PA, 19103-6996, US

(21) Appl. No.: 10/641,957

(22) Filed: Aug. 15, 2003

(51) Int. Cl. B60K 1/00

(52) U.S. Cl. 180/65.8

(57) ABSTRACT

A personal mobility vehicle is steered by handlebars. A lever is mounted on the handlebars and rotatable in either of two opposite directions by the hands holding the handlebars. A potentiometer connected to the lever comprises a wiper on a resistive track, centered by a spring. The track has a central null area formed by material of lower resistance, so that the output voltage is constant. When the lever is moved away from the centered position, the wiper moves along the track and the output voltage rises or falls. A controller controls the speed and direction of the vehicle in response to the output voltage of the potentiometer. When the wiper is on the null area, the controller stops the vehicle. The size of the null area facilitates ensuring the centered position coincides with the null area, so the vehicle stops when the lever is released.

### FIELD OF THE INVENTION

The present invention relates to vehicles, and particularly to a throttle control for a vehicle, and in particular a personal mobility vehicle.

### BACKGROUND OF THE INVENTION

A personal mobility vehicle is a motorized, usually battery powered, electric vehicle, typically utilized by a person who is able to walk but is not able to walk long distances. Such vehicles typically have a seat with a back, positioned above a pair of drive wheels. Batteries power one or more drive motors, which are typically positioned below the seat. In front of the seat is a footplate, on which a person sitting in the seat can rest his or her feet. In front of the footplate is an upstanding tiller, with handlebars at the top. The tiller is connected to a front wheel, or a pair of front wheels. Rotating or moving the tiller turns the front wheel or wheels and steers the vehicle.

Typically, any controls that the user needs to operate while the vehicle are positioned on the tiller, adjacent to the handlebars. (See, for example, commonly-assigned U.S. Patent Application Publication No. 20020003055.) A throttle for controlling vehicle speed and direction is often controlled by a lever pivotably mounted on the middle of the handlebars, with one end of the lever operated by the user's left hand and the other end operated by the user's right hand. As one end of the lever is squeezed, typically by the right hand, the position of the lever generates a signal commanding forward motion of the vehicle, with the speed generally proportional to how far the lever is moved. When the other end of the lever is squeezed, a signal is generated commanding reverse movement of the vehicle. When the lever is released, a restoring spring (or springs) returns it to a central position, which results in the power being cut to the motor and, typically, results in the motor being used as a brake to slow and stop the vehicle.

In order to provide a null position in the control and/or to generate a control signal for motor braking, it is necessary to accurately position the lever or other throttle control. If the null or neutral position of the throttle control is not accurately located, the vehicle may experience a forward or reverse drive motion from the motors when the throttle is released. Moreover, the neutral position is desired to be sufficiently robust for practical use.

### SUMMARY OF THE INVENTION

The present invention provides a speed control device for a vehicle, preferably of the type where the user operates a control to activate electric drive motors. The speed control device includes a potentiometer that provides a signal to a motor controller to regulate the current flow to the motor. The potentiometer has variable resistance on either side of a central position. The central position defines a “dead” or null area in which a specific output is generated over a range of control positions. This specific output signals the controller to brake the vehicle to a stop. The null area needs to be sufficiently large that the self-centering mechanism reliably parks the potentiometer in the null area, even after any shift in centering or increase in play that may occur as a result of wear during normal use.

The potentiometer is a rotary potentiometer. To reduce tilting of the relatively rotatable components, and consequent possible errors in the position of the potentiometer, the potentiometer has an effective length at least equal to its effective diameter. For this purpose, the effective length and effective diameter of a bearing are the length and diameter of the surface or notional surface at which the relative movement between the components occurs. If movement is not confined to a single surface, for example, because there is an intermediate component such as a roller race, then the lowest length-to-diameter ratio, usually that measured at the surface of greatest diameter, should generally be measured.

In one embodiment, the rotor of the potentiometer has a wiper that contacts a continuously increasing resistive track on the stator. A central, neutral position is defined where the potentiometer has a specific resistance value. This neutral position is extended by means of a conducting layer over the resistive material, to form a null section within which the resistive track has a specific and constant value. The wiper is mounted on a shaft that is journaled in a cylindrical plain bearing in a sleeve fixed coaxial with the resistive track. The length and internal diameter of the bushing of the plain bearing then define the effective length and effective diameter of the bearing.

### BRIEF DESCRIPTION OF THE DRAWINGS

For purposes of illustrating the invention, the drawings show one or more forms in which the invention can be embodied. The invention is not, however, limited to the precise forms shown unless such limitation is expressly made in a claim. In the drawings:

FIG. 1 is a perspective view of an embodiment of a personal mobility vehicle for use with the present invention.

FIG. 2 is an enlarged top view of the handlebars of the vehicle shown in FIG. 1, partially cut away to show a potentiometer.

FIGS. 3A, 3B, and 3C are top sectional views of the potentiometer shown in FIG. 2, in different operating positions.

FIG. 4 is a side elevation view of the potentiometer shown in FIG. 2, partly in section.

FIG. 5 is a section along the line 5-5 in FIG. 2.

FIG. 6 is a partly exploded perspective view of the potentiometer shown in FIG. 2.

FIG. 7 is an enlarged detail of part of the potentiometer shown in FIG. 6.

FIG. 8 is a block diagram of the drive circuit for a vehicle, incorporating the present invention.

FIG. 9 is an axial section through part of the potentiometer shown in FIG. 4.

### DETAILED DESCRIPTION OF THE INVENTION

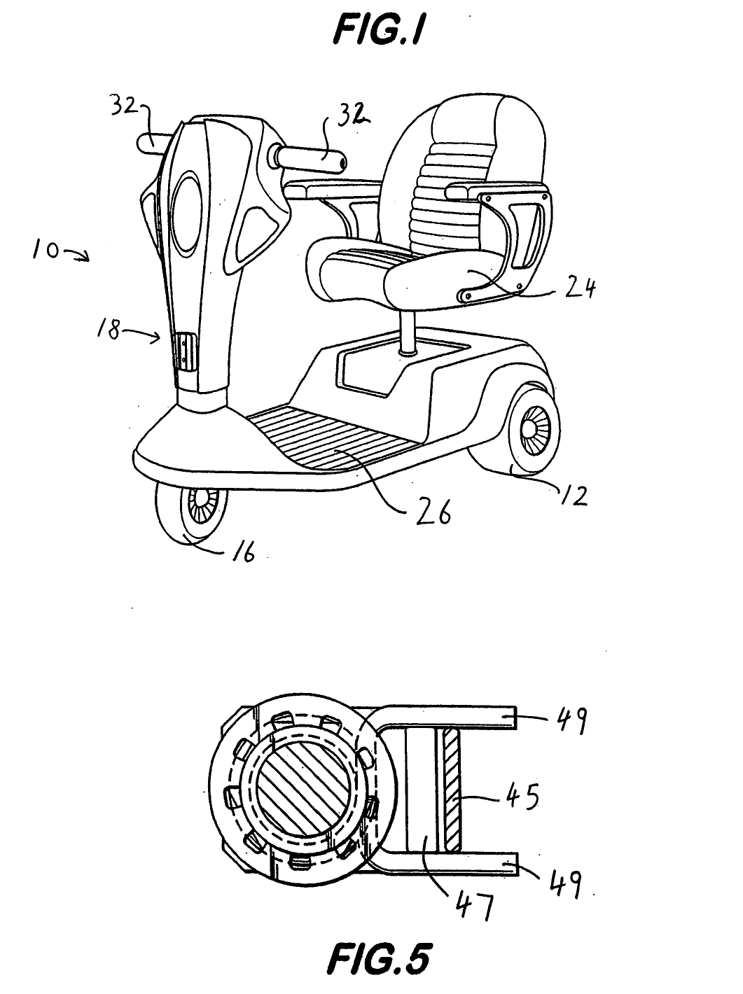

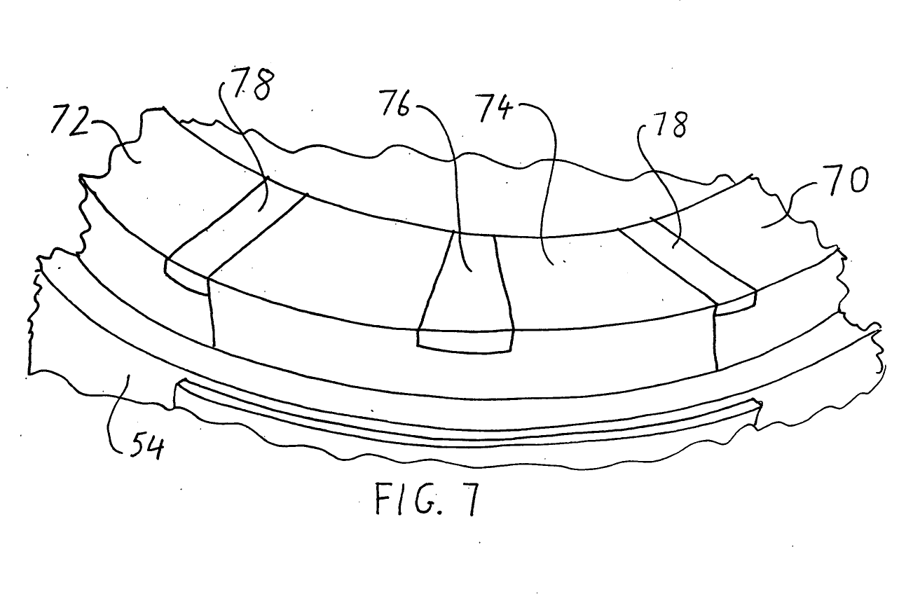

Referring to the drawings, and initially to FIG. 1, one form of personal mobility vehicle of the invention is a scooter, designated generally by the reference numeral 10. The scooter 10 has three wheels, with a pair of rear wheels 12 driven by a motor (not shown, but designated generally in FIG. 7 as item 14) and a single front wheel 16. The front wheel 16 can be steered by means of a tiller generally indicated by the reference numeral 18. The motor drives the two rear wheels 12 through a differential (item 20 in the FIG. 7 schematic) to allow the rear wheels to move at different speeds on curves. The motor 14 may include reduction gearing or the like (not shown) to reduce the speed of rotation of the actual motor to that of the wheels. The drive motor, differentials and reduction gearing are contemplated to take any form as desired and in the interests of conciseness are not further described herein.

A seat 24 is mounted towards the rear of the scooter 10. Between the seat 24 and the tiller 18, a footplate 26 extends the entire width of the scooter 10. The footplate 26 is several inches above ground level, when the scooter 10 is resting on its wheels 10 and 16, in order to allow clearance underneath for the scooter to pass over obstacles and uneven ground. The height of the seat 24 is set so that a user (not shown) can sit on the seat with his or her feet resting on the footplate 26.

The motor is typically mounted in the rear part of the scooter 10, behind the footplate 26 and under the seat 24. A power supply (item 30 in the schematic of FIG. 7) is typically in the form of one or more electric storage batteries, and is usually also mounted in the rear of the scooter, below the seat.

The tiller 18 includes a pair of handlebars 32, projecting from either side near the top. By rotating the handlebars and thereby turning the tiller 18 to one side or the other, the user may rotate the front wheel 16, steering the scooter to the left or right. The mechanisms for mounting and coupling the handlebars, tiller, and front wheel so as to achieve this steering action may take any conventional form and, in the interests of conciseness, are not further described herein.

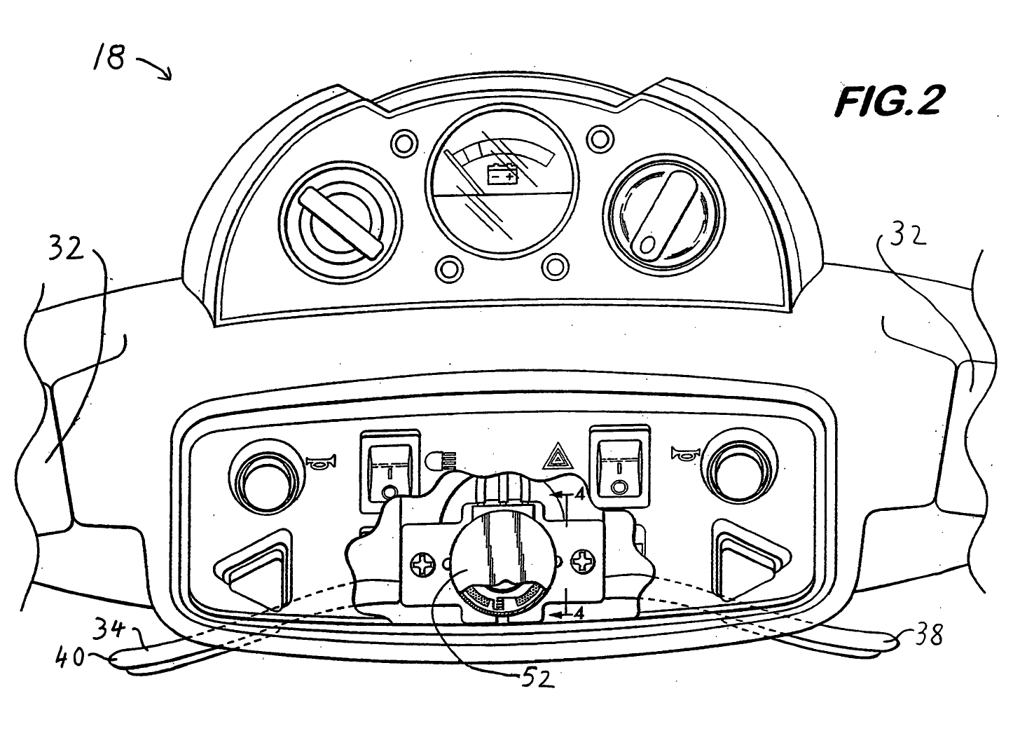

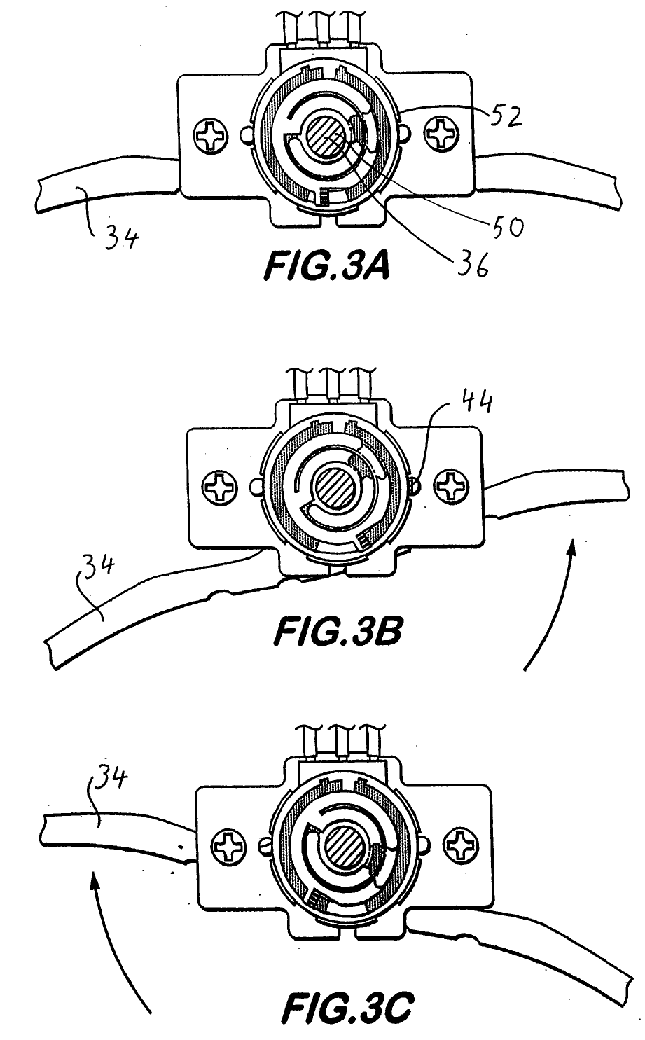

Referring now to FIGS. 2 and 3, to control the speed of the scooter there is provided a lever 34, pivotally mounted at 36 at the center of the handlebars 32, and extending to either side. The ends 38, 40 of the lever 34 are positioned near the inner ends of the handlebars 32 and to the rear of the handlebars, that is to say, on the side towards a user sitting in the seat 24. The ends 38, 40 of the lever 34 are close enough to the handlebars 32 to be reached by the thumbs of the user while also holding the handlebars, but far enough away that the user can cause an appreciable rotation of the lever 34 by squeezing one of the ends 38 or 40 against the adjacent handlebar 32. In the construction shown in FIG. 2, in the rest position each end 38 or 40 of the lever 34 is approximately 4 inches (10 centimeters) from the handlebar 32, and the lever is approximately 16 inches (40 centimeters) from end to end. The lever 34 can thus rotate through an arc of about 30° from end to end, or 15° either side of its central rest position. As shown in FIGS. 2 and 3, the lever 34 is mounted by being fixed to the rotor shaft 50 of a rotary potentiometer 52.

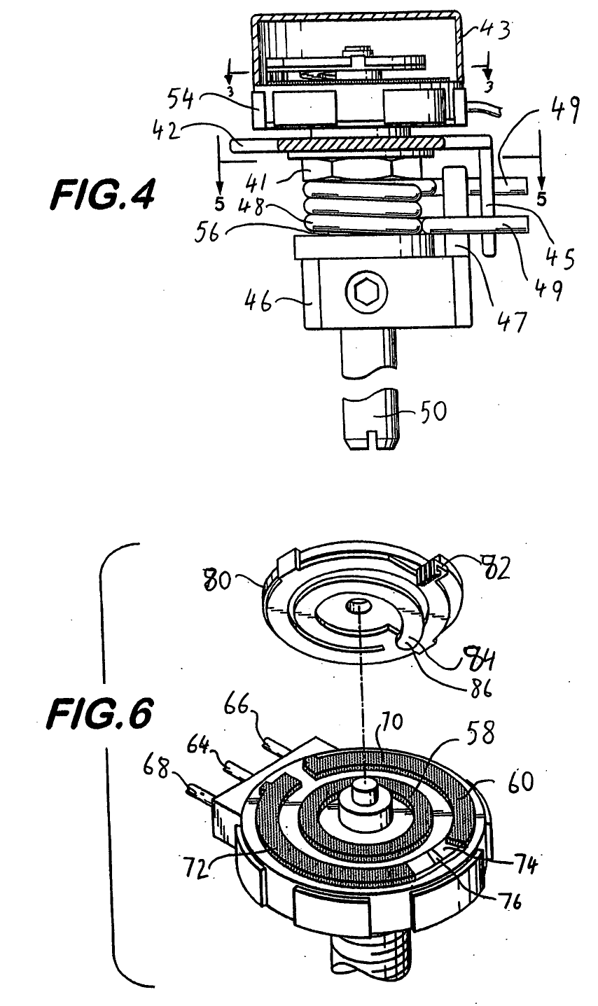

Referring now to FIGS. 4 to 6, the potentiometer 52 comprises a body 54 of electrically insulating material mounted on a threaded sleeve 56, by means of which the potentiometer is mounted to a convenient part of the tiller 18 that is rigidly connected to the handlebars 32. The rotor shaft 50 is journaled within the sleeve 56, in a manner that will be described in more detail below. In known manner, the rotor shaft 50 and the sleeve 56 may be provided with flats, lugs, or other formations by which they may be easily aligned during installation. The threaded sleeve 56 is clamped by a nut 41 onto a bracket 42, which is fixed to the tiller 18. A cap 43 clamped to the potentiometer body 54 is also secured against rotation relative to the bracket 42 by a key 44. The bracket has an upstanding tab 45 on one side.

A collar 46, having a tab 47 projecting down form one side, is fastened to the rotor shaft 50 by a set screw. The tab 47 overlaps axially with the tab 45, and is of the same circumferential width as the tab 45. A coil spring 48 is wound round the threaded sleeve 56, and has two tangentially projecting ends 49 that rest against the sides of the tabs 45 and 47 with a torsional preload. The spring 48 thus maintains the tabs 45, 47 in alignment, and provides a restoring force returning them to the aligned position, and thus returning the rotor shaft 50 and the potentiometer body to a corresponding relative orientation, in the event of rotation. That relative orientation may be adjusted by releasing the set screw and rotating the potentiometer shaft 50 within the collar 46. If that adjustment is not required, the rotor shaft 50 may be provided with a flat or recess into which the set screw can lock at a predetermined orientation.

One face of the body 54 is provided with an inner, circular track 58 of electrically conductive material of low resistance, preferably silver, and an outer, horseshoe track 60 forming an almost complete circle. Three electrical leads 64, 66, 68 are respectively connected to the conductive track 58 and to each end of the arcuate track 60. The ends of the leads 64, 66, 68 that connect to the tracks may be printed from conductive ink on the surface of the body 54, preferably under the track 60, provided that the end of the lead 64 is appropriately isolated from the track 60 where it crosses the radius of the latter track.

Referring now also to FIG. 7, the arcuate track 60 consists mainly of two sections 70, 72 of electrically conductive material of low resistance, preferably silver, connected at one end to the leads 66, 68, respectively. The other ends of the conductive sections 70, 72 are approximately 30° apart, and are joined by a track 74 of electrically resistive, but not fully insulating, material. At the center of the resistive track 74 is a strip of conductive material 76 covering, or recessed into, the surface of the resistive track 74. Adjacent to each end of the resistive track 74, the surfaces of the conductive sections 70, 72 are provided with roughened areas 78. If the conductive sections are made of silver, the roughened areas may be formed by making the surface of the silver porous. Instead, an abrasive may be incorporated into the conductive material to form the roughened areas 78.

In the interests of clarity, the tracks 58 and 60 have been shown with appreciable thickness, and as projecting upward from the surface of the potentiometer body 54. However, it is preferred to form them from layers of electrically conductive, resistive, and insulating ink of negligible thickness printed onto the surface of the body 54. Preferably, at least the resistive track 74, which provides the variable resistance of the potentiometer, is then printed on top of an undercoat 67 of dielectric ink, in order to provide a smooth substrate. This is found to improve the flatness of the resistive layer 74 and to produce a considerable reduction in wear and improvement in the service life of the potentiometer. The resistive layer may be printed in two or more coats. This also improves the service life of the potentiometer. Although not shown in the drawings, the ends of the resistive track 74 and the adjacent ends of the conductive sections 70, 72 may be overlapped.

Fixed to the end of the rotor shaft 50 is an insulating disc 80, which carries a pair of wipers 82, 84, one of which runs on the track 60, and the other of which runs on the conductive track 58. The wipers 82, 84 are formed from a single piece of metal, or otherwise electrically connected, and thus connect the conductive track 58 to the point on the resistive track 74 that the wiper 82 is resting on. The wiper 84 resting on the circular conductive track 58 merely needs to ensure a good contact, and has a flat contact surface 86 engaging the track 58. The wiper 82 resting on the track 60 needs to establish contact at a precise circumferential position, because its position along the resistive track 74 determines the output of the potentiometer. Consequently, the wiper 82 is angled, with the outside of the angle forming substantially a line contact, extending radially, with the track 60. The rotor shaft 50 is positioned in the collar 46 at an orientation such that the spring 48 centers the potentiometer with the wiper 82 on the center of the conductive strip 76. As will be explained below, the spring 48 must reliably center the potentiometer 52 with the wiper somewhere on the conductive strip 76. Thus, the circumferential length of the conductive strip 76 provides a tolerance for play or drift in the centering mechanism.

If the leads 66, 68 are connected to the ends of the track 60, and a constant voltage is imposed between the leads 66, 68, a readout of the position of the wiper 82 can be obtained very simply in the form of a voltage at a high-impedance output from the lead 64. This readout indicates the orientation of the rotor shaft 50, and thus of the position of the lever 34. In this arrangement, the conductive section 76 provides a substantial part of the travel of the rotor shaft 50 within which the output voltage does not change.

The length of the resistive track 74 is related to the travel of the lever 34 so that, when the lever 34 is at either end of its travel, the wiper 82 rests on one of the roughened areas 78. This has two advantages. First, the roughened areas 78 act as an abrasive to clean the wiper 82. Second, the resistive material 74 is not very durable, and may eventually wear out entirely. If that happens, the vehicle 10 can still be operated, albeit with reduced control, by rotating the lever 34 until the wiper 82 contacts one of the conductive regions 70, 72. The controller 88 will then recognize a command to drive the vehicle at full speed in the appropriate direction.

When the user is not squeezing either end of the lever 34, it is centered automatically by the spring 48. When the lever 34 is centered by the spring 48, the wiper 82 rests on the conductive section 76, which forms a null area between the two halves of the resistive track 74. This section is formed by a section of conductive ink overprinted on top of the resistive ink forming the resistive track 74. The reading from the potentiometer is then constant while the wiper 82 is anywhere on the null area 76. Because the null area 76 is of significant width, the precision of the centering mechanism 80 does not have to be very high.

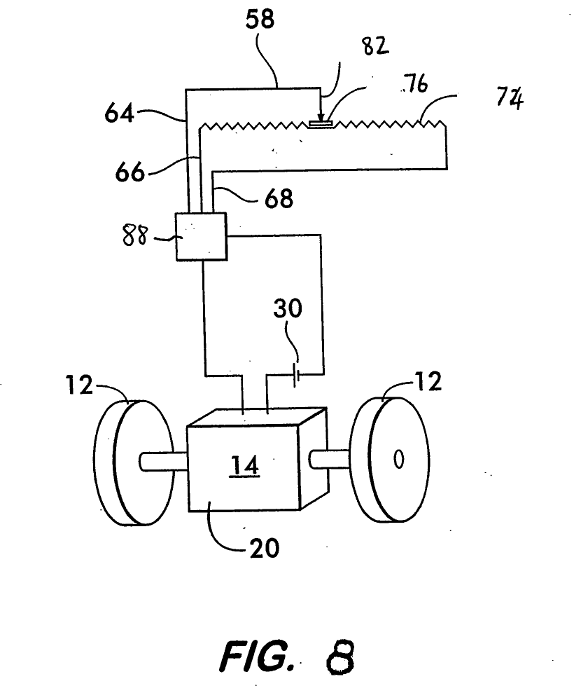

Referring now to FIG. 8, the leads 64, 66, 68 are connected to a controller 88, which measures the voltage at the lead 64 relative to the voltage difference between the leads 66 and 68. The measured voltage represents the position of the wiper 82, and thus the desired speed and direction of the vehicle. The controller 88 controls the power supplied by the battery 30 to the motor 14 accordingly. When the wiper 82 is on the null area 76, the output voltage at the lead 64 has a constant value, roughly in the middle of the range. As the lever 34 is rotated, once the wiper 82 is off the null area 76, the output voltage rises, if the lever is turned one way, or falls, if the lever is turned the other way, proportionately to the distance of movement of the ends 38, 40 of the lever.

The controller is programmed to supply power to the motor 14 to propel the vehicle at a speed proportional to the amount of movement of the lever 34 and in a direction indicated by the direction of movement of the lever 34 away from the central rest position. The controller 88 is programmed to brake the vehicle when the output from the potentiometer is in a narrow range that includes the output when the wiper 82 is on the null area 76. If the absolute value of that output drifts over time, for example, because of uneven wear of the resistive track 64, then it would be possible for the controller 88 to recognize the null voltage, because it will always appear as a constant output for a significant period of time as the wiper 82 crosses the null area, and recalibrate itself accordingly.

Because of the very small distances traveled by the wiper 82 over the active part of the resistive track, and especially the small null area 76, it is important to ensure that the rotor shaft 50 rotates in the threaded sleeve 56 without tilting. In particular, if the rotor shaft 50 were to tilt about a transverse axis at the end of the threaded sleeve 56 further from the body 54, the effect could be a significant displacement of the wiper 82 along the track 60.

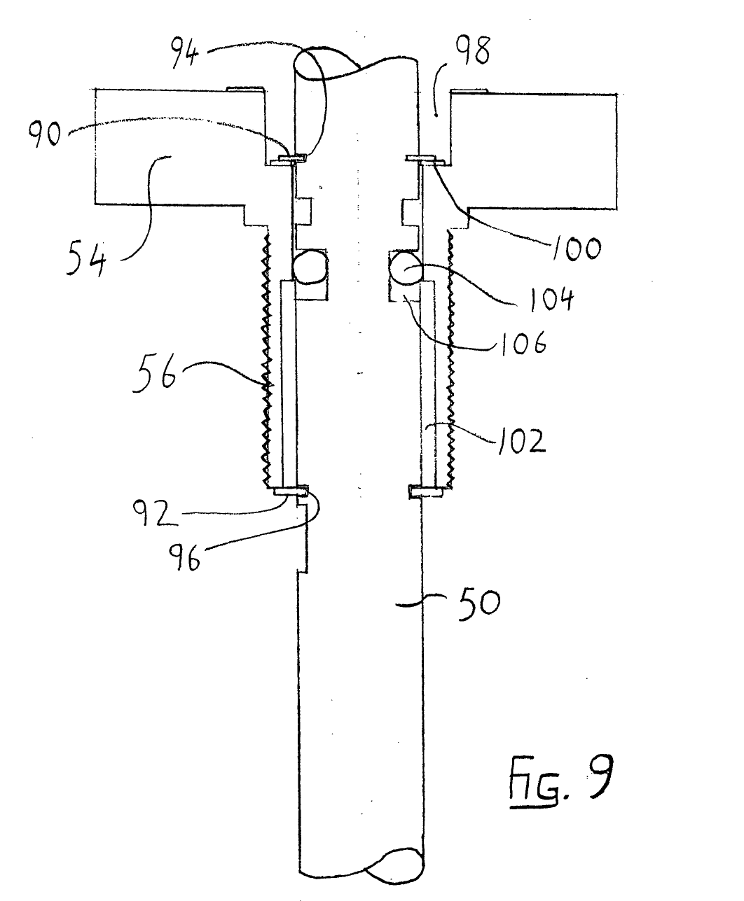

Referring now to FIG. 9, the rotor shaft 50 is located axially within the threaded sleeve 56 by two C-clips 90 and 92 set in grooves 94, 96 in the rotor shaft. One of the C-clips 90 is positioned within a recess 98 in the body 54 of the potentiometer, inside the conductive track 58. The abutment between the C-clip 90 and the bottom of the recess 98 acts as a thrust bearing, receiving the axial force produced by the springiness of the wipers 82 and 84. The axial force is not large, but to give smoother rotation a washer 100 is provided between the C-clip 90 and the bottom of the recess. The other C-clip 92 engages the free end of the threaded sleeve 96. A washer similar to the washer 100 is preferably also provided under the C-clip 92.

Seated in a recess inside the free end of the threaded sleeve 56, and retained in position by the C-clip 92, is a sleeve 102 that forms a plain bearing for the rotor shaft 50. The bearing sleeve 102 is preferably made of bearing bronze or other copper alloy that provides a smooth bearing on the metal, typically steel, of the rotor shaft 50. The bearing sleeve 102 fits into the threaded sleeve 56 as snugly as is consistent with ease of assembly, and fits the rotor shaft 50 as closely as is consistent with easy rotation, in order to minimize play. To minimize tilting of the rotor shaft 50, the bearing sleeve 102 is longer than the diameter of the shaft, preferably about 1½ times as long as the inside diameter of the shaft. The part of the inner bore of the threaded sleeve 56 between the bearing sleeve 102 and the first C-clip 90 is of diameter slightly wider than the internal diameter of the bearing sleeve, so that the rotor shaft 50 is journaled in the bearing metal of the bearing sleeve 102, and not in the metal, typically steel, of the threaded sleeve 56.

The C-clip 92, including any washer, is preferably of sufficiently large outside diameter that it overlaps the threaded sleeve 56 outside the bearing sleeve 102, and is of sufficiently small diameter that it does not hinder threading of the nut 41 onto and off the threaded sleeve.

An 0-ring 104 is seated in a groove 106 in the rotor shaft 50. The 0-ring 104 serves to seal the only opening into the interior of the potentiometer. The 0-ring 104 engages either the bearing sleeve 102 or the interior wall of the threaded sleeve 56 between the bearing sleeve 102 and the first C-clip 90. Preferably, as shown in FIG. 9, the 0-ring may be positioned so that it rests on the end of the bearing sleeve 102, exerting a slight axial pressure that further reduces play in the mounting of the rotor shaft 50. However, this may result in increased wear of the 0-ring from contact with the angular rim of the bearing sleeve 102. Alternatively, therefore, the 0-ring may be spaced away from the bearing sleeve 102, and may engage the slightly wider part of the central bore of the threaded sleeve 56.

Although a specific embodiment of the invention has been described, various modifications are possible. For example, the part of the resistive track 74 under the conductive strip 76 could be omitted, so that the two halves of the resistive track 74 are separate. This would allow a thicker conductive strip 76 without an undesirably high bulge in the track surface that the wiper 82 runs on.

Alternatively, the layer 76 could be formed of dielectric material, instead of conductive material. The central rest position of the potentiometer may then be recognized as a position in which no output signal is received. The part of the resistive layer under the dielectric layer 76 may then be omitted, so that the two halves of the resistive track 74 are separate. In this arrangement, the controller 88 measures the resistances between the lead 64 and each of the leads 66, 68 (one of which resistances should be very high) to identify the desired direction and speed of movement.

The construction shown in the drawings, with the lever 34 mounted directly on the rotor shaft 50 of the potentiometer 52, is mechanically very simple and reliable. However, it does involve a very small travel of the wiper 82 on the track 60, approximately 30° of arc as shown in the drawings, and consequently requires precise manufacture of the potentiometer. It would be possible instead to increase the travel of the wiper 82, for example, by introducing gearing between the lever 34 and the rotor shaft 50.

Further, although the vehicle 10 has been described and illustrated as a three-wheeled scooter, it will be appreciated that the speed control of the invention could be applied to a four-wheeled scooter, or indeed to any vehicle with a speed control that is moved away from a central rest position in one direction to command forward motion and in the opposite direction to command backward motion, with the amount of movement of the control commanding the speed of movement.

The present invention may be embodied in other specific forms without departing from the spirit thereof and, accordingly, reference should be made to the appended claims, rather than to the foregoing specification, as indicating the scope of the invention.

1. A speed control for an electrically powered, motorized vehicle, comprising:
a control operable by a user of the vehicle, and arranged to be moved in two opposite directions from a rest position;
a potentiometer comprising a wiper and at least one resistor, mounted on the vehicle for relative rotation and so connected to the control that when the control is moved away from the rest position in either of the two opposite directions the wiper moves along the at least one resistor in a corresponding direction;
a controller electrically connected to the wiper and to said at least one resistor, and responsive to an electrical quantity indicative of the position of the wiper along the at least one resistor to control the speed and direction of the vehicle;
wherein one of said wiper and said resistor is supported on a member journaled in a bearing having a length greater than its effective diameter;
wherein when said control is in a rest zone including said rest position the electrical quantity has a constant value; and
wherein said controller is responsive to said electrical quantity having said constant value to discontinue power to the motors of the vehicle.

2. The speed control of claim 1, wherein said control is biased into said rest position.

3. The speed control of claim 1, wherein said at least one resistor is a single resistor, a part of which corresponding to said rest zone comprises material of lower resistance.

4. The speed control of claim 3, wherein said single resistor comprises a resistive track.

5. The speed control of claim 4, wherein said material of lower resistance of said rest zone is overlaid on said resistive track.

6. The speed control of claim 1, wherein said bearing is a plain bearing.

7. The speed control of claim 1, wherein the length of said bearing is substantially 1 1/2 times its effective diameter.

8. The speed control of claim 1, wherein one of said wiper and said at least one resistor is arranged to be fixed to part of the vehicle, and the other is arranged to be rotated by movement of said user-operable control.

9. The speed control of claim 1 for a vehicle with handlebars, wherein said user-operable control comprises a lever arranged to extend along the handlebars, either end of which may be moved by the user's hand without releasing the handlebars.

10. A personal mobility vehicle, comprising:
a pair of handlebars;
a lever mounted on the handlebars and rotatable in either of two opposite directions by the hands of a user of the vehicle while holding the handlebars, and biased into a central rest position;
a potentiometer mounted on said handlebars and comprising a wiper and at least one resistor, said potentiometer so connected to said lever that when the lever is in the rest position the wiper is in contact with a null area of the at least one said resistor, and when the lever is moved away from the rest position in either of the two opposite directions the wiper moves along the at least one resistor in a corresponding direction, said wiper and said resistor mounted for relative rotation by a bearing having an effective length at least equal to its effective diameter;
a controller electrically connected to the wiper and to the at least one resistor, and responsive to an electrical quantity indicative of the position of the wiper along the at least one resistor to control the speed and direction of the vehicle,
the electrical quantity having a substantially constant value while the wiper is in the null area.

11. The vehicle of claim 10, wherein the null area comprises a material of relatively lower resistance.

12. The vehicle of claim 10, wherein said at least one resistor comprises a resistive track laid on an insulating surface of said potentiometer.

13. The vehicle of claim 10, wherein the effective length of the bearing is about 1.5 times its effective diameter.

14. A personal mobility vehicle, comprising:
steering means for steering the vehicle;
a lever mounted on said steering means and rotatable in either of two opposite directions by the hands of a user of the vehicle while holding the holding the steering means, and biased into a central rest position;
a potentiometer mounted on the steering means and comprising a wiper and an arcuate resistor arranged in use to have a potential difference between its ends, the potentiometer connected to the lever such that when the lever is in the rest position the wiper rests on a part of the resistor comprising material of relatively lower electrical resistance, and when the lever is moved away from the rest position in either of the two opposite directions one of said wiper and said resistor rotates relative to the other so that the wiper moves along the resistor in a corresponding direction, said wiper and said resistor being connected by a bearing having an effective length at least equal to its effective diameter;
a controller electrically connected to the wiper and responsive to the potential of the resistor at the position of said wiper to control the speed and direction of the vehicle, the controller being responsive to the voltage setting designated by position of the wiper on said the resistor.
